(19) United States
(12) Patent Application Publication
(10) Pub. No.: US 2006/0059269 A1
(43) Pub. Date: Mar. 16, 2006

(54) Transparent recovery of switch device

(76) Inventors: Chien Chen, Fremont, CA (US); Richard L. Schober, Cupertino, CA (US); Yolin Lih, San Jose, CA (US); Ian Colloff, Los Gatos, CA (US); Richard J. Reeve, San Mateo, CA (US); Allen Lyu, Saratoga, CA (US); Mohamed Magdy Talaat, San Jose, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/939,531

(22) Filed: Sep. 13, 2004

(51) Int. Cl. G06F 15/16

(52) U.S. Cl. 709/235; 709/226

(57) ABSTRACT

An interconnect device for transmitting data packets includes a plurality of ports, a hub, and an arbiter. The hub is configured to connect the plurality of ports together. The arbiter is coupled to the hub for controlling transmission of data packets between the hub and the ports. A reset is provided in at least one of the ports. The reset is in communication with the arbiter such that arbiter can reset the port in response to a detected error in the port.

### BACKGROUND

Many existing networking technologies, such as Peripheral Component Interconnect (PCI) architecture, have not kept pace with the development of computer systems. Many such systems are challenged by the ever increasing traffic and demands of the Internet. Several technologies have been implemented in an attempt to meet the computing demands and require increased capacity to move data between processing nodes, such as servers, as well as within a processing node between a central processing unit (CPU) and input/output (I/O) devices.

In an attempt to meet these demands, improved interconnect technology has been implemented. One such example is called InfiniBand® architecture (hereinafter “IBA”). IBA is centered around point-to-point, switched fabric in which end node devices may be interconnected utilizing a cascade of switch devices. IBA may be implemented to interconnect numerous hosts and various I/O units, or between a CPU and a number of I/O modules. Interconnect technologies such as IBA, utilize switches, routers, repeaters and/or adaptors having multiple input and output ports through which data (or data packets) is directed from a source to a destination. As demand on these interconnected networks increase with higher bandwidth and speed requirements, the various components of the network must continue to increase in performance and availability in order to keep up with demand. For these and other reasons, a need exists for the present invention.

### SUMMARY

One aspect of the present invention provides an interconnect device for transmitting data packets. The interconnect device includes a plurality of ports, a hub, and an arbiter. The hub is configured to connect the plurality of ports together. The arbiter is coupled to the hub for controlling transmission of data packets among the ports. A plurality of resets are provided in the ports and the arbiter. The resets are in communication such that a port can reset other ports and the arbiter and the arbiter can reset the other ports when an error or errors are detected.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is a block diagram illustrating a network system.

FIG. 2 is a block diagram illustrating a switch.

FIG. 3 is a block diagram illustrating further details of a switch in accordance with the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

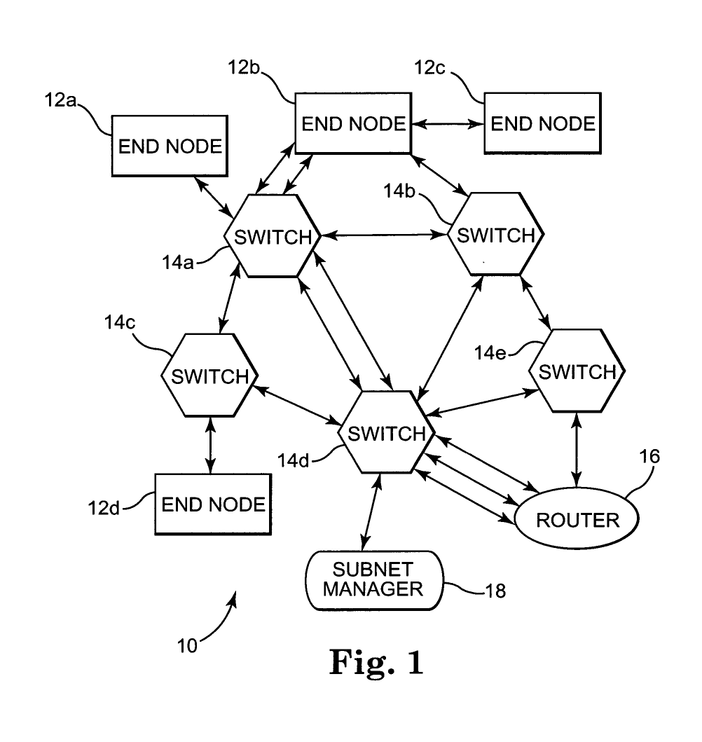

FIG. 1 is a block diagram illustrating a network system 10. Network 10 may be a network or a sub-network, also referred to as a subnet, which is interconnected by routers to other subnets to form a larger network. Within network 10, end nodes may connect to a single subnet or multiple subnets. Network 10 may be any type of switched network. For example, network 10 could be an InfiniBand® architecture (hereinafter “IBA”) defining a switched communications fabric that allows multiple devices to concurrently communicate with high bandwidth and low latency in a protected and remotely managed environment. An InfiniBand® Trade Association has developed and published an IBA specification that details the interconnect technology standards of operation. Other switched networks are also represented by network 10 Network 10 illustrates four end nodes 12a, 12b, 12c, and 12d located within network 10. As known by those of ordinary skill in the art, an end node may represent a number of different devices, examples of which include, a processor end node, a router to a network, or an I/O device, such as a redundant array of independent disks (RAID) subsystem. Also illustrated are switches 14a, 14b, 14c, 14d, and 14e. Furthermore, network 10 includes router 16 and a subnet manager 18. Multiple links can exist between any two devices within network 10, an example of which is shown by connections between router 16 and switch 14d.

Switches 14a, 14b, and 14c connect the end nodes 12a, 12b, 12c, and 12d for communication purposes. Each connection between an end node 12a, 12b, 12c, and 12d and a switch 14a, 14b, and 14c is a point-to-point serial connection. Since the connections are point-to-point, four separate connections are required to connect the end nodes 12a, 12b, 12c, and 12d to switches 14a, 14b, and 14c, as opposed to the requirement of a shared bus connection used within a PCI bus.

It should be noted that more than four separate connections are illustrated in FIG. 1 to provide examples of different connections within network 10. In addition, since each point-to-point connection is dedicated to two devices, such as end nodes 12a, 12b, 12c, and 12d and switches 14a, 14b, 14c, 14d, and 14e, the full bandwidth capacity of each connection is made available for communication between the two devices. This dedication eliminates contention for a bus, as well as delays that result from heavy loading conditions on a shared bus architecture.

It should also be noted that more or fewer end nodes 12a, 12b, 12c, and 12d may be located within network 10. Router 16 provides a connection from the network 10 to remote subnets for the transmission and reception of data packets. In addition, the end nodes 12a, 12b, 12c, and 12d may be any logical device that is located within the network 10. As an example, the end nodes 12a, 12b, 12c, and 12d may be processor nodes and/or I/O devices.

Due to the structure of switches 14a, 14b, 14c, 14d, and 14e and functionality performed therein, each are capable of controlling the flow of data packets either from an end node 12a, 12b, 12c, and 12d to another end node 12a, 12b, 12c, and 12d, from an end node 12a, 12b, 12c, and 12d to the router 16, or from the router 16 to an end node 12a, 12b, 12c, and 12d.

Switches 14a, 14b, 14c, 14d, and 14e transmit packets of data based upon a destination address, wherein the destination address is located in a local route header of a data packet. However, switches 14a, 14b, 14c, 14d, and 14e are not directly addressed in the traversal of packets within network 10. Instead, packets traverse switches 14a, 14b, 14c, 14d, and 14e virtually unchanged. To this end, each destination within network 10 is typically configured with one or more unique local identifiers, which represent a path through a switch 14a, 14b, 14c, 14d, and 14e.

Data packet forwarding by a switch 14a, 14b, 14c, 14d, and 14e is typically defined by forwarding tables located within each switch 14a, 14b, 14c, 14d, and 14e, wherein the table in each switch is configured by subnet manager 18. Each data packet contains a destination address that specifies the local identifier for reaching a destination. When individual data packets are received by a switch 14a, 14b, 14c, 14d, and 14e, the data packets are forwarded within the switch 14a, 14b, 14c, 14d, and 14e to an outbound port or ports based on the destination local identifier and the forwarding table located within the switch 14a, 14b, 14c, 14d, and 14e.

Router 16 forwards packets based on a global route header located within the packet, and replaces the local route header of the packet as the packet passes from subnet to subnet. While intra-subnet routing is provided by the switches 14a, 14b, 14c, 14d, and 14e, router 16 is the fundamental routing component for inter-subnet routing. Therefore, routers interconnect subnets by relaying packets between the subnets until the packets arrive at a destination subnet. As additional devices, such as end nodes, are added to a subnet, additional switches are normally required to handle additional packet transmission within the subnet. However, it would be beneficial if additional switches were not required with the addition of end nodes, thereby reducing the expenditure of resources associated with the purchase of additional switches.

As stated above, network 10 may be illustrated by way of example as IBA. Thus, network 10 is capable of providing flow control of data packets within a network, such as an IBA, using IBA switches. It should be noted, however, that it is not required that the switch be utilized in association with an IBA. In addition, due to structure of switches such as an IBA switch, the illustrated switches may be easily modified to compensate for the addition of end nodes to network 10, as well as added packet flow associated with the addition of end nodes. One skilled in the art will recognize that other crossbar and related switches can be used in network 10.

Switches 14a, 14b, 14c, 14d, and 14e are transparent to end nodes 12a, 12b, 12c, and 12d, meaning they are not directly addressed (except for management operations). Instead, packets transverse the switches 14a, 14b, 14c, 14d, and 14e virtually unchanged. To this end, every destination within network 10 is configured with one or more unique local identifiers (LID). From the point of view of a switch 14, a LID represents a path through the switch. Packets contain a destination address that specifies the LID of the destination. Each switch 14a, 14b, 14c, 14d, and 14e is configured with forwarding tables (not shown) that dictate the path a packet will take through the switch 14a, 14b, 14c, 14d, and 14e based on a LID of the packet. Individual packets are forwarded within a switch 14a, 14b, 14c, 14d, and 14e to an out-bound port or ports based on the packet's destination LID and the switch's 14a, 14b, 14c, 14d, and 14e forwarding table. IBA switches support unicast forwarding (delivery of a single packet to a single location) and may support multicast forwarding (delivery of a single packet to multiple destinations).

The subnet manager 18 configures the switches 14a, 14b, 14c, 14d, and 14e by loading the forwarding tables into each switch 14a, 14b, 14c, 14d, and 14e. To maximize availability, multiple paths between end nodes 12a, 12b, 12c, and 12d may be deployed within the switch fabric. If multiple paths are available between switches 14a, 14b, 14c, 14d, and 14e, the subnet manager 18 can use these paths for redundancy or for destination LID based load sharing. Where multiple paths exist, the subnet manager 18 can re-route packets around failed links by re-loading the forwarding tables of switches in the affected area of the fabric.

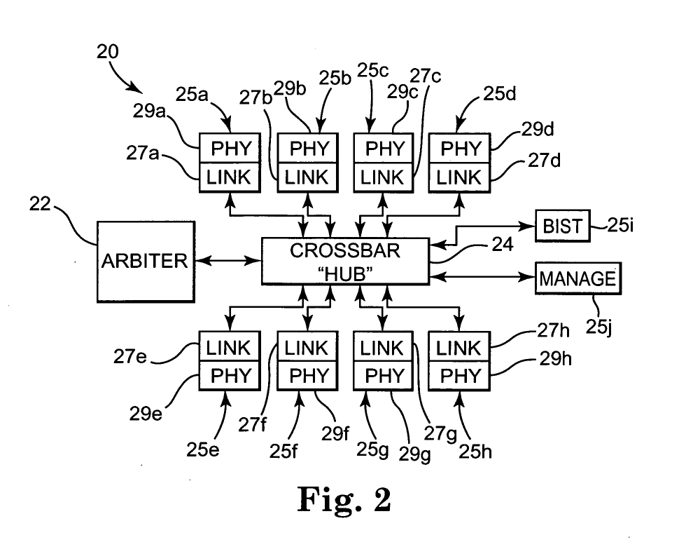

FIG. 2 is a block diagram further illustrating a switch 20, such as switches 14a, 14b, 14c, 14d, and 14e of FIG. 1, in accordance with the exemplary embodiment of the invention. Switch 20 includes an arbiter 22, a crossbar or “hub” 24, and a plurality of ports 25a-25j (collectively referred to as “ports 25”). For exemplary purposes, eight input/output ports 25a-25h, built-in-self-test (BIST) port 25i and a management port 25j are illustrated within switch 20. It should be noted that more or fewer ports 25 may be located within switch 20, depending upon the number of end nodes and routers connected to switch 20 and/or other network factors.

Switch 20 directs a data packet from a source end node to a destination end node, while providing data packet flow control. As is known by those having ordinary skill in the art, a data packet contains at least a header portion, a data portion, and a cyclic redundancy code (CRC) portion. The header portion contains at least a source address portion, a destination address portion, a data packet size portion and a virtual lane identification number. In addition, prior to transmission of the data packet from an end node, a CRC value for the data packet is calculated and appended to the data packet.

In switch 20, input/output ports 25a-25h each contain an input module and an output module and each are connected through hub 24. Each input/output port 25a-25h of switch 20 generally comprises a link block 27a-27h (collectively referred to as “link blocks 27”) and a physical block (“PHY”) 29a-29h (collectively referred to as “PHY blocks 29”). In one embodiment, hub 24 is a ten port device with two ports being reserved for management functions. For example, these management functions may include BIST port 25i and management port 25j. BIST block 25i supports a built-in self-test functionality. The eight communication ports 25a-25hare coupled to hub 24 and each issue resource requests to arbiter 22, and each receive resource grants from arbiter 22. As one skilled in the art will recognize, more or less ports 25 may be used. For example, another embodiment could have 20 ports, with 18 communications ports and 2 ports reserved for management functions.

PHY blocks 29 primarily serve as serialize to de-serialize (“SerDes”) devices. Link blocks 27 perform several functions, including input buffer, receive (“RX”), transmit (“TX”), and flow control. Input virtual lanes (VLs) are physically contained in input buffers (not shown in FIG. 2) of link blocks 27. Other functions that may be performed by link blocks 27 include: integrity checking, link state and status, error detecting and recording, flow control generation, and output buffering.

While hub 24 interconnects ports 25a-25j, arbiter 22 controls interconnection between ports 25a-25j via hub 24. Specifically, hub 24 contains a series of wired point-to-point connections that are capable of directing data packets from one port 25 to another port 25. Arbiter 22 contains a request preprocessor and a resource allocator. The request preprocessor determines a port 25 within switch 20 that is to be used for transmitting a received data packet to a destination end node. It should be noted that the port 25 to be used for transmitting received data packets to the destination end node is also referred to herein as the outgoing port.

For exemplary purposes, the following assumes that the outgoing port is port 25d and that a source port is port 25a. To determine the outgoing port 25d, the request preprocessor uses a destination address stored within the header of the received data packet to index a routing table located within the request preprocessor and determine the outgoing port 25d for the received data packet. Arbiter 22 also determines availability of the outgoing port 25d and regulates transmission of received data packets, via switch 20, to a destination end node.

In some instances, transmission of data packets in switch 20 may encounter an error, such as a fatal, non-recoverable control error. A fatal control error may be when the switch control logic enters an ambiguous or illegal state or an unexpected event occurs that cannot be handled in an appropriate manner. As previously mentioned, subnet manager 18 may re-route packets around failed links, such as those that have encountered errors, by re-loading the forwarding tables of switches. In addition, subnet manager 18 also typically then performs a reset on the device within which the fatal control error took place. For example, if a fatal error was encountered in transmitting a data packet in port 25a to port 25d of switch 20, subnet manager 18 may re-route the data packet through another switch and then would reset switch 20 through a device reboot.

Such a device reboot of switch 20 will reset the device to its power-on state. Such a reboot will bring down the ports of switch 20 to an initialized state. This reset by subnet manager 18 causes switch 20 to loose all of its configuration information, and thus, management software resident in subnet manager 18 is then needed to reconfigure switch 20 from the initial state. In some instances, this reconfiguration process of switch 20 by subnet manager 18 may require more than 500 management packets be transferred from subnet manager 18 to switch 20 to complete the reconfiguration. The transfer of that many packets could take as long as 0.5 seconds of down time for switch 20 thereby slowing speed and degrading overall performance of network 10.

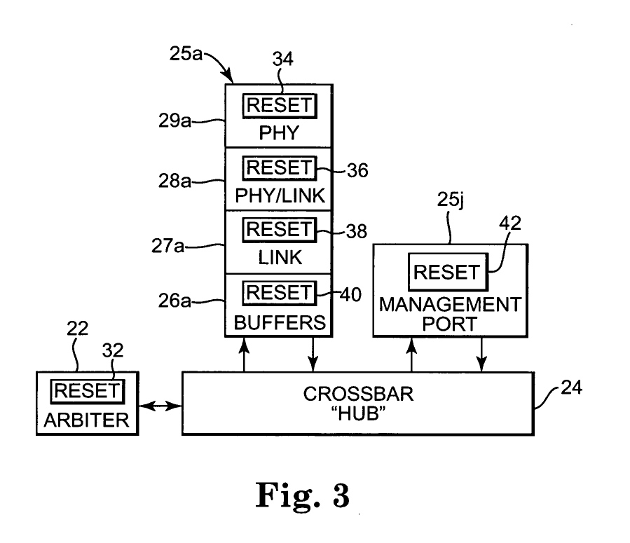

FIG. 3 is a block diagram illustrating a portion of switch 20 in accordance with the present invention. More specifically, FIG. 3 illustrates a more detailed view of input/output port 25a, arbiter 22, and management port 25j. Port 25a includes buffers block 26a, link block 27a, PHY/Link interface 28a, and PHY block 29a. Furthermore, arbiter 22, buffers block 26a includes reset block 40, link block 27a includes reset block 38, PHY/Link interface 28a includes reset block 36, and PHY block 29a includes reset block 34, and management Port 25j includes reset block 42. Other ports, such as input/output ports 25b-25h illustrated in FIG. 2, are not illustrated in FIG. 3, in order to simplify the discussion, but the details of those ports may be configured similarly to the illustrated port 25a.

It will also be appreciated by those of ordinary skill in the relevant arts that switch 20, as illustrated in FIG. 3, and the operation thereof as described hereinafter is intended to be generally representative of such systems and that any particular switch may differ significantly from that illustrated in FIG. 3, particularly in the details of construction and operation. Further, only those functional elements that have bearing on the present invention have been portrayed so as to focus attention on the salient features of the inventive features. As such, switch 20 is to be regarded as illustrative and exemplary and not limiting in regard to the invention described herein.

Illustrated port 25a includes PHY block 29a, which is operable to perform functions related to the physical operation of the switch. PHY/LINK block 28a serves as the switch interface between the physical switch operation and the logical switch operation. Link block 27a contains the functionality related to the transfer of data to a remote location using hub 24. Buffer block 26a performs the switch specific operations related to sending and receiving packets across hub 24. Arbiter 22 manages the requests for transport across switch 20 and ensures that switch 20 transports packets across hub 24 without contention while meeting the requirements of data packets originated from a plurality of end users.

Port 25a also includes reset blocks 34, 36, 38 and 40 within PHY block 29a, PHY/Link interface 28a, link block 27a, and buffers block 26a, respectively. Similarly, arbiter block 22 and management port 25j are provided with reset blocks 32 and 42. As arbiter 22 and management port 25j manage the requests for transport across switch 20 and an error is, or errors are, encountered in the transmission via port 25a, reset blocks 32-42 can be utilized in conjunction with arbiter 22 and management port 25j in order to reboot port 25a without the intervention of subnet manager 18. In fact, the reboot of switch 25 can be transparent to subnet manager 18 via the use of reset blocks 32-42. Consequently, switch 20 of the present invention can reboot when an error is encountered without involving management software avoiding the transmitting management packets thereby increasing speed and overall performance of network 10. In this way, in one embodiment of switch 20 a reboot and error recovery within switch 20 takes less than 100 microseconds.

Because port 25a (as well as the other ports 25b-25h) of switch 20 may be rebooted by arbiter 22 or other ports 26a-29a in conjunction with reset blocks 32-42 without the involvement of subnet manager 18, switch 20 does not need to be reconfigured each time an error such as a control error is encountered by switch 20. Switch 20 may be rebooted by arbiter 22 in conjunction with reset blocks 32-42 without loosing the configuration settings of switch 20. Not having to reconfigure switch 20 saves time in not requiring the transmission of configuration packets and allows network 10 to provide higher availability and to operate more efficiently.

In one embodiment, switch 20 in accordance with the present invention utilizes an error recovery protocol already built in to PHY block 29. For example, where switch 20 is an IBA switch, IBA defines error recovery protocol in the PHY block of a port within an IBA switch. This error recovery protocol is built into IBA switches to deal with physical errors encountered by the IBA switch. The error recovery protocol detects when a fatal errors, such as state machine corruption, occur in the switch. Such a control error is detected by on-chip logic. When switch 20 according to one embodiment of the invention encounters a fatal control error, such as at port 25a, the error recovery protocol then generates a signal indicative of the fact that an error was detected and resets 32-42 are activated in order to perform a reboot.

Because ports 25a-25h use known control errors, those devices in communication with switch 20 will perceive that switch 20 has experienced a physical error, even though switch 20, or at least port 25a of switch 20, in being rebooted. When a fatal control error is encountered by ports 25a-25h, the port will appear to devices with which they are communicating as if they are in an active deferred state. By using known error states during the reboot, communication with other switches and components will not be interrupted or otherwise cause unknown state errors.

In one embodiment, ports 25a-25h each contain reset blocks are described for port 25a, which are each capable of being individually activated. In this way, only those individual ports of a switch 20 affected by an error need be reset by arbiter 22, and those ports of switch 20 unaffected continue transmitting packets transparent to the other port or ports being reset. In another embodiment, all of the reset blocks of the various ports 25a-25h are all tied together such that when the arbiter 22 detects an error in any port 25a-25h, it will activate the reset in all ports 25a-25h. In this way, when a fatal control error occurs in any of ports 25a-25h arbiter 22 will activate the reset blocks in all ports 25a-25h. In either case, the reset occurs in switch 20 without interaction with subnet manager 18, thereby avoiding having to reconfigure the switch and saving processing time.

When fatal control errors occur in switch 20, the port affected by the error is typically in communication with a partner, such as with the port of another switch or an end node. Arbiter 22 in switch 20 tracks when a fatal control error occurs, and in addition to initiating the reset blocks in ports 25a-25h, arbiter 22 also tracks the packets that are flushed with the reset so that it can negotiate with the partner that was in communication with port in which the error occurred. Often it will be the case that the reset will cause packets to be flushed out of the affected port. Arbiter 22 can then re-transmit those packets that were lost by the reset to the partner that was in communication with the reset port once communication is again established with the communication partner after the reboot. Arbiter 22 also tracks which ports were not affected by the error, and in the situation where these unaffected ports are not reset, no negotiation is needed with partners in communication with these unaffected ports.

Once again, since the tracking of lost packets and negotiation with partners in communication with the port affected by fatal errors is handled by arbiter 22, no involvement of subnet manager 18 is required, and thus, no software set-up of the affected switch 20 is required by subnet manager 18. In fact, with the present invention the occurrence of the error and resulting reboot within switch 20 may be transparent to subnet manager 18. The event of the error may be logged within the port of switch 20 so that subnet manager 18 can come back later and find out what did happen to the switch.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An interconnect device for transmitting data packets, the interconnect device comprising:
a plurality of ports;
a hub connecting the plurality of ports;
an arbiter coupled to the hub for controlling transmission of data packets between the hub and the ports; and
a reset block in at least one of the ports and in the arbiter, the reset blocks in communication with the arbiter such that arbiter can initiate the reset block to reboot the at least one port in response to a detected error in the at least one port.

2. The interconnect device of claim 1, wherein the arbiter resets the at least one port without any software intervention from outside the interconnect device.

3. The interconnect device of claim 1, wherein the arbiter resets the at least one port without loosing configuration information for the interconnect device.

4. The interconnect device of claim 1, wherein each of the plurality of ports further comprise a physical block and a link block.

5. The interconnect device of claim 4, wherein the reset block is contained in the physical block and the link block of each of the plurality of ports.

6. The interconnect device of claim 1, wherein the arbiter is configured to negotiate with partners that are in communication with the interconnect device when the interconnect device is in a reboot such that packets that are flushed with the reboot may be retransmitted to the partner.

7. The interconnect device of claim 1, wherein the arbiter reboots only the port that is affected by the error and does not reboot any ports that are not affected by the error.

8. The interconnect device of claim 1, wherein the arbiter reboots all of the ports in the interconnect device when any of the ports are affected by the error.

9. The interconnect device of claim 1, wherein interconnect device logs the reboot of the switch such that the interconnect device can be subsequently polled with regard to the error and the reboot.

10. The interconnect device of claim 1, wherein arbiter reboots the switch in less than 100 microseconds.

11. The interconnect device of claim 1, wherein the interconnect device is in InfiniBand switch.

12. An InfiniBand network comprising:
a plurality of end nodes;
a subnet manager in communication with the end nodes; and
at least one InfiniBand switch, the at least one InfiniBand switch further comprising:
a plurality of ports;
a hub connecting the plurality of ports;
an arbiter coupled to the hub for controlling transmission of data packets between the hub and the ports; and
a reset block in at least one of the ports and in the arbiter, the reset blocks in communication with the arbiter such that arbiter can reboot the at least one port in response to a detected error in the at least one port.

13. The InfiniBand network of claim 12, wherein the arbiter resets the at least one port in the InfiniBand switch without any intervention from the subnet manager.

14. The InfiniBand network of claim 12, wherein the arbiter in the InfiniBand switch resets the at least one port without loosing configuration information for the InfiniBand switch.

15. The InfiniBand network of claim 12, wherein each of the plurality of ports in the InfiniBand switch further comprise a physical block and a link block wherein the reset block is contained in the physical block and in the link block of each of the plurality of ports.

16. The InfiniBand network of claim 12, wherein the arbiter in the InfiniBand switch reboots only the port that is affected by the error and does not reboot any ports that are not affected by the error.

17. The InfiniBand network of claim 12, wherein the arbiter in the InfiniBand switch reboots all of the ports in the InfiniBand switch when any of the ports are affected by the error.

18. A method for rebooting an interconnect device with an arbiter and with a plurality of ports connected by a hub that is configured to transmit data packets, the method comprising:
detecting when an error occurs in a port in the transmission of data packets in the plurality of ports;
placing the port affected by the error in an active deferred state;
initiating the rebooting of the interconnect device by the arbiter within the interconnect device resetting the port affected by the error; and
wherein the rebooting of the interconnect device occurs without any software intervention from outside the interconnect device.

19. The method of claim 18 wherein the arbiter resets the port affected by the error without loosing configuration information for the interconnect device.

20. The method of claim 18 wherein the arbiter negotiates with partners that are in communication with the interconnect device when the interconnect device is in a reboot such that packets that are flushed with the reboot may be retransmitted to the partner.
